(19) United States
(12) Patent Application Publication
(10) Pub. No.: US 2026/0279348 A1
(43) Pub. Date: Sep. 17, 2026

(54) SYSTEMS AND METHODS FOR AN ADAPTIVE VOICE INTERFACE WITH EMOTIONAL STATE DETECTION, MULTI-MODEL ROUTING, AND DOMAIN-SPECIFIC RETRIEVAL AUGMENTED GENERATION

(71) Applicant: Joseph MERCOLA, Ormond Beach, FL (US)

(72) Inventor: Joseph MERCOLA, Ormond Beach, FL (US)

(21) Appl. No.: 19/565,931

(22) Filed: Mar. 13, 2026

Related U.S. Application Data
(60) Provisional application No. 63/772,004, filed on Mar. 14, 2025.

(51) Int. Cl. G10L 15/183; G10L 13/033; G10L 15/18; G10L 15/22; G10L 25/63

(52) U.S. Cl. CPC G10L 15/183; G10L 13/033; G10L 15/1807; G10L 15/22; G10L 25/63; G10L 2015/223

(57) ABSTRACT

A voice assistant system and method incorporates emotional state detection, multi-model large language model routing, and domain-specific retrieval augmented generation. The system receives user inputs through voice and multi-modal input devices, performs voice analysis including prosody analysis to detect emotional cues and determine the user's emotional state, and adjusts task prioritization, workflow, response content, and user interface presentation based on the detected emotional state. A router selects from a plurality of large language models based on cost, performance, latency, user satisfaction, and input content, with an abstraction layer transforming inputs and outputs for cross-model compatibility. A fallback mechanism switches models when outputs are unacceptable. Domain-specific information is retrieved from vector databases and provided to the selected model through advanced context layers. The system incorporates adaptive communication style adjustment, controlled imperfections for humanlike output, consistent personality maintenance, conversation steering rules, and continuous learning from user interactions.

### CROSS-REFERENCE TO RELATED APPLICATIONS

This application claims priority to and the benefit of U.S. Provisional Application No. 63/772,004, filed on Mar. 14, 2025, and titled “Systems and Methods for a Voice Interface”, the contents of which are hereby incorporated herein by reference in their entirety.

### FIELD OF THE INVENTION

The present invention relates generally to a voice assistant system, and more specifically, to generative artificial intelligence large language models that generate conversation outputs, including emotional state detection, to produce humanlike conversation interactions.

### BACKGROUND OF THE INVENTION

Voice assistants are an increasingly popular tool, and there is a desire to create a voice assistant that can provide humanlike conversations with a user. One method to create humanlike conversation is to use a large language model to generate responses to a user's inputs to the voice assistant. Large language models have become increasingly popular, and the number of high performing large language models has grown extremely quickly. Additionally, newly released or updated large language models frequently outperform older large language models.

Traditionally, a device with a voice assistant may be programmed to use one particular large language model. This limits the voice assistant\'s capabilities to the capabilities of a single model and possibly prevents improvements in large language models from being realized by the user of the voice assistant. There exists a need for a voice assistant architecture that can dynamically switch between different large language models so that the voice assistant\'s user can enjoy the benefits of improved large language models as they become available without requiring replacement of the voice assistant system.

Additionally, many large language models perform best when they are provided inputs in a form that is very different from a naturally spoken input that a user may give to a voice assistant. There exists a need for an architecture that allows a voice assistant to receive spoken inputs that are ordinary verbal communication while still providing the large language model with an input that the large language model is able to effectively process in order to generate a response to the user.

Moreover, many large language models generate outputs that do not resemble natural speech. Although a large language model may generate grammatically correct and coherent outputs, the output may sound unnatural or unlike human speech when spoken aloud. There exists a need for an architecture that allows a voice assistant to use a large language model to generate a response to a user's input while maintaining the humanlike qualities of the voice assistant's output, including emotional responsiveness, personality consistency, and natural conversational flow.

Furthermore, many existing voice assistants may not provide the ability to detect and respond to the emotional state of a user in real time, to adjust their communication style based on detected emotional cues, to maintain contextual memory across conversations, and to retrieve domain-specific information from specialized knowledge bases to augment the generative capabilities of the underlying large language model. As such, there exists a need for an integrated voice assistant architecture that combines emotional state detection, adaptive response generation, multi-model routing, domain-specific retrieval augmented generation, and humanlike conversational capabilities in a unified system.

The present disclosure provides a solution for these and other problems.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

The present disclosure is generally directed generally to an adaptive voice assistant system and method that addresses limitations of existing voice assistant architectures through the integration of emotional state detection, multi-model large language model routing, domain-specific retrieval augmented generation, adaptive communication style adjustment, and humanlike conversational output generation.

According to one aspect of the present disclosure, a method includes receiving a user input on an input device, performing voice analysis on the user's input, determining based on the voice analysis an emotional state of the user, generating using a large language model a response to the user input that is responsive to the determined emotional state, and outputting to the user the response using an output device.

According to another aspect of the present disclosure, a voice assistant system includes a voice interface configured to receive spoken inputs from a user through a microphone and other input devices, to perform advanced speech recognition including prosody analysis to detect emotional cues, to transform spoken inputs into a form that a large language model can process, and to output responsive outputs through speakers, screens, and other output devices. The voice interface incorporates multi-modal input processing including voice, text, gesture, and facial expression recognition, and produces outputs that incorporate controlled imperfections, consistent personality traits, and emotion-modulated text-to-speech synthesis to create humanlike conversational interactions.

According to another aspect of the present disclosure, a multi-model routing architecture includes a router configured to select a large language model from a plurality of large language models based on one or more of a predetermined priority list, user selection, user satisfaction data, tracked performance metrics including latency and cost, and the content of the user input. The routing architecture includes a fallback mechanism that switches to a different large language model when the selected model fails, produces unacceptable outputs, or when a different model could produce better outputs. The routing architecture further includes an abstraction layer that transforms inputs to the format required by the selected large language model and transforms outputs for consistency across different models and conversations.

According to another aspect of the present disclosure, a retrieval augmented generation system includes a vector database containing domain-specific information and a voice interface configured to retrieve domain-specific information relevant to a user input and provide both the user input and the retrieved information to a large language model for response generation. The system incorporates advanced context layers including a user query layer containing the current input and conversation history, a retrieved knowledge layer containing relevant domain-specific information, an emotional context layer containing emotional information determined from user input analysis, a system instruction layer containing behavioral guidelines and guardrails, and a personalization layer containing user-specific information and preferences.

According to another aspect of the present disclosure, an adaptive communication system analyzes a user's communication style including personality, tone, speaking rate, expressiveness, and language patterns, determines whether imitating or adjusting the communication style will produce positive user experiences, and incrementally adjusts a voice assistant's communication style across conversations based on observed user responses.

According to another aspect of the present disclosure, a conversation management system incorporates conversation steering rules that reject or modify inputs or outputs to maintain topical boundaries, turn-taking mechanisms that mimic natural dialogue flow, user data management with anonymization and encryption, and adaptive learning algorithms that continuously improve a voice assistant based on successful and unsuccessful interactions.

According to another aspect of the present disclosure, a task execution system includes a voice assistant that receives a task request, performs the requested task, outputs a notification of task completion, analyzes the user's response to determine satisfaction, and takes corrective action when the task has not been completed to the user's satisfaction.

According to another aspect of the present disclosure, a computer-implemented method is directed to operating a voice assistant and includes receiving a spoken input from a user through a microphone or voice-enabled input device. The method further includes performing voice analysis on user input, the voice analysis including prosody analysis to detect emotional cues in the user's speech, wherein the prosody analysis extracts from the speech pitch, tempo, energy, and spectral-tilt features. The method further includes determining, based on the voice analysis, an emotional state of the user by mapping the extracted prosody-derived features to an emotional-state label from a predefined emotional-state set. The method further includes selecting, using a router, a large language model from a plurality of large language models based on weighted scoring of latency, cost, and prior user-satisfaction metrics. The method further includes assembling a multi-layer prompt for the selected large language model, the prompt incorporating a user query layer containing the current user input and conversation history, a retrieved knowledge layer containing domain-specific information, an emotional context layer containing the determined emotional-state label, a system instruction layer containing predefined assistant guidelines, and a personalization layer containing user-specific preferences. The method further includes generating, using the selected large language model, a response to the user input based on the assembled prompt. The method further includes screening the generated response by comparing it against stored rejection rules in a configuration database and determining a confidence score, and replacing the response or selecting a fallback large language model from the plurality of large language models when the confidence score is below a predetermined threshold or when the response matches a stored rejection rule. The method further includes outputting, to the user, the response, using an output device, wherein the output incorporates modulation of text-to-speech parameters based on the determined emotional state.

According to another aspect of the present disclosure, a non-transitory computer-readable medium stores a set of instructions, the set of instructions including one or more instructions that, when executed by one or more processors of a device, cause the device to receive a spoken input from a user through a microphone or voice-enabled input device. The instructions further cause the device to perform voice analysis on user input, the voice analysis including prosody analysis to detect emotional cues in user speech, wherein the prosody analysis extracts from the speech pitch, tempo, energy, and spectral-tilt features. The instructions further cause the device to determine, based on the voice analysis, an emotional state of the user by mapping the extracted prosody-derived features to an emotional-state label from a predefined emotional-state set; select, using a router, a large language model from a plurality of large language models based on weighted scoring of latency, cost, and prior user-satisfaction metrics. The instructions further cause the device to assemble a multi-layer prompt for the selected large language model, the prompt incorporating a user query layer containing current user input and conversation history, a retrieved knowledge layer containing domain-specific information, an emotional context layer containing the determined emotional-state label, a system instruction layer containing predefined assistant guidelines, and a personalization layer containing user-specific preferences. The instructions further cause the device to generate, using the selected large language model, a response to the user input based on the assembled prompt. The instructions further cause the device to screen the generated response by comparing it against stored rejection rules in a configuration database and determining a confidence score, and replacing the response or selecting a fallback large language model from the plurality when the confidence score is below a predetermined threshold or when the response matches a stored rejection rule. The instructions further cause the device to output, to the user, the response, using an output device, wherein the output incorporates modulation of text-to-speech parameters based on the determined emotional state.

According to another aspect of the present disclosure, a voice assistant system includes a voice interface configured to receive spoken inputs from a user through a microphone and text inputs from other user input devices. The voice assistant system further includes a voice analysis module within the voice interface configured to perform prosody analysis to extract pitch, tempo, energy, and spectral-tilt features, and to determine an emotional state of the user by mapping the extracted prosody-derived features to emotional-state labels from a predefined emotional-state set. The voice assistant system further includes a plurality of large language models configured to receive inputs and generate responsive outputs, and a router configured to select one large language model from the plurality of large language models based on weighted scoring of latency, cost, and prior user-satisfaction metrics. The voice assistant system further includes an abstraction layer configured to transform user inputs to a form processable by the selected large language model and to transform outputs for consistency across different models and conversations. The voice assistant system further includes a response screening module configured to compare generated responses against stored rejection rules in a configuration database and determine a confidence score. The voice assistant system further includes a fallback mechanism configured to switch to a next-highest-ranked large language model from the plurality when the generated response matches a stored rejection rule or when the confidence score is below a predetermined threshold. The voice assistant system further includes a vector database containing domain-specific information, wherein the voice interface is configured to retrieve domain-specific information relevant to user inputs and provide the retrieved information to the selected large language model. The voice assistant system further includes a prompt assembly module configured to assemble multi-layer prompts incorporating a user query layer, a retrieved knowledge layer, an emotional context layer containing the determined emotional-state label, a system instruction layer, and a personalization layer. The voice assistant system further includes an output system configured to output responsive outputs through at least one of a speaker or screen, wherein the responsive outputs incorporate emotion-modulated text-to-speech parameters based on the determined emotional state.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments and are therefore not to be considered as limitations on the scope of the various embodiments or claims.

FIG. 1 is a diagrammatic illustration representing a technical environment for a voice assistant device, in accordance with an exemplary embodiment of the present disclosure.

FIG. 2A is a diagrammatic illustration representing components for a voice assistant device, in accordance with an exemplary embodiment of the present disclosure.

FIG. 2B is a flowchart illustrating a method that uses the voice assistant device of FIG. 2A with a feedback loop cycle, in accordance with an exemplary embodiment of the present disclosure.

FIG. 3 is a flowchart illustrating a method that uses a voice assistant device for adaptive communication style adjustment, in accordance with another exemplary embodiment of the present disclosure.

FIG. 4 is a flowchart illustrating a method that uses a voice assistant device for emotional state-based response adjustment, in accordance with another exemplary embodiment of the present disclosure.

FIG. 5 is a flowchart illustrating a method that uses a voice assistant device for task execution, in accordance with another exemplary embodiment of the present disclosure.

FIG. 6A is a diagrammatic illustration representing components for a voice assistant device, in accordance with another exemplary embodiment of the present disclosure.

FIG. 6B is a flowchart illustrating a method that uses the voice assistant device of FIG. 6A, in accordance with another exemplary embodiment of the present disclosure.

FIG. 7A is a diagrammatic illustration representing components for a voice assistant device containing a router, in accordance with another exemplary embodiment of the present disclosure.

FIG. 7B is a flowchart illustrating a method that uses the voice assistant device of FIG. 6A, in accordance with another exemplary embodiment of the present disclosure.

FIG. 8 is a flowchart illustrating a method that uses a voice assistant device, in accordance with another exemplary embodiment of the present disclosure.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

Additionally, the following detailed description sets forth the adaptive voice interface system and method with reference to the accompanying drawings. The description provides sufficient detail to enable a person having ordinary skill in the art of artificial intelligence systems, voice interface design, natural language processing, and software architecture to make and use the invention. The embodiments described herein are illustrative and not limiting. The described embodiments may be practiced in forms and configurations not specifically described but that fall within the scope of the appended claims. Unless otherwise stated, technical and scientific terms have the meaning commonly understood by one of ordinary skill in the art. Method steps disclosed in the figures may be rearranged, combined, or divided without departing from the envisioned embodiments, and additional steps may be added or steps may be removed without departing from the envisioned embodiments.

As used herein, unless specifically stated otherwise, the term “or” encompasses all possible combinations, except where infeasible. For example, if it is stated that a component may include A or B, then unless specifically stated otherwise or infeasible, the component may include A, or B, or A and B.

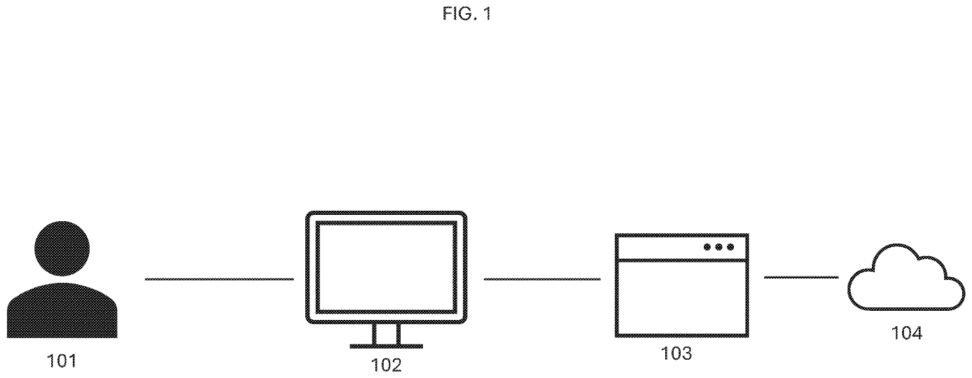

Referring now to FIG. 1, generally, a user interacts in an exemplary technical environment with a voice assistant device running voice assistant software either locally or through a web browser connected to cloud-hosted voice assistant software, consistent with the disclosed embodiments. More specifically, a user (101) uses a device (102) with the voice assistant installed or running on a non-transitory computer-readable medium that stores data on the device (102) that also includes a processor. The device (102) is any device capable of running the voice assistant software, such as a cell phone, a laptop, a tablet, a desktop computer, a wearable device, a smart home device, or any other computing device. The voice assistant operates locally on the device (102) or is operated using a web browser (103), an application, or other user interface that is connected to a cloud-hosted voice assistant software (104). The user (101) interacts with the voice assistant through a variety of input means on the device (102) to initiate and conduct a conversation with the voice assistant. The voice assistant uses a variety of means to create and output responses from the device (102) to the user (101) to provide a positive experience to the user.

The device (102) optionally includes a display. The display includes, for example, liquid crystal displays, light-emitting diode screens, organic light-emitting diode screens, touch screens, and/or other known display devices. The display shows various information to a user including one or more user interface elements. The device (102) optionally includes one or more input/output devices, including, for example, a camera, a microphone, a keyboard, a mouse-type device, a gesture sensor, an action sensor, a physical button, and other input/output devices. The input/output devices further include, optionally, one or more communication modules for sending and receiving information by establishing wired or wireless connectivity.

The device (102) further includes a processor in the form of a microprocessor. The processor is optionally a single-core or multiple-core processor that executes parallel processes simultaneously. The processor optionally uses logical processors to simultaneously execute and control multiple processes. The processor optionally implements virtual machine technologies or other known technologies to provide the ability to execute, control, run, manipulate, store, and otherwise manage multiple software processes, applications, and programs. The processor further optionally includes a multiple-core processor arrangement configured to provide parallel processing functionalities.

The device (102) further includes a memory, which stores one or more operating systems that perform operating system functions when executed by the processor. The operating system functions included, but are not limited to, Microsoft Windows, Unix, Linux, Android, Mac OS, iOS, or other types of operating systems. The memory is a volatile, non-volatile, magnetic, semiconductor, tape, optical, removable, non-removable, or other type of storage device or tangible computer-readable medium.

The device (102) further includes a data structure storage such as a database. The data structure storage includes relational databases, non-relational databases, NoSQL databases, or any combination thereof. The data structure storage stores data that is used by the processor for performing methods and processes associated with the disclosed embodiments. The data structure storage is located in a system of the disclosed embodiments or alternatively in external storage devices located outside of the system.

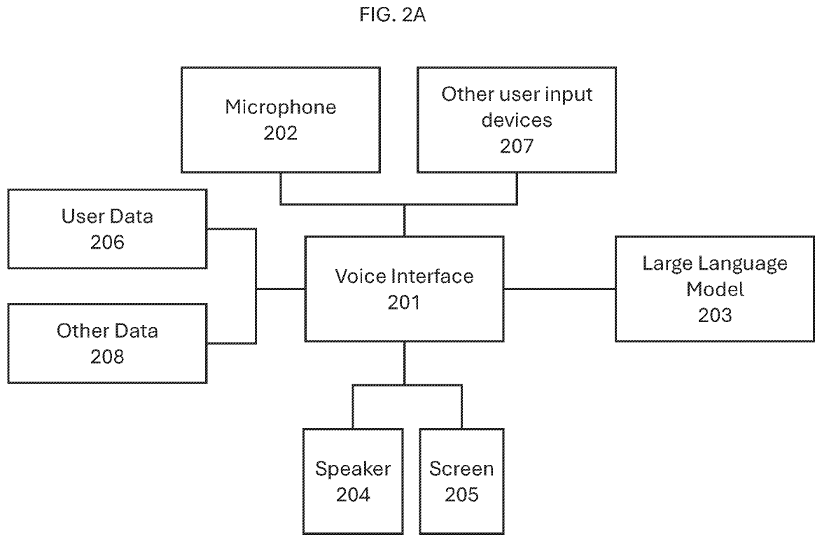

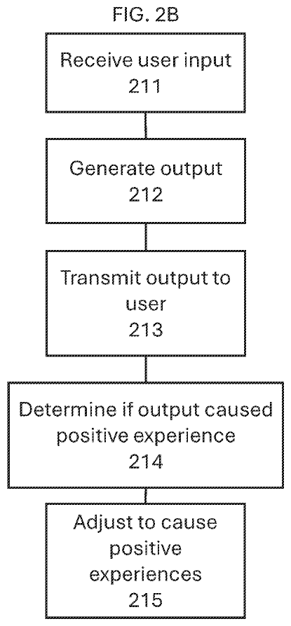

Referring now to FIG. 2A, generally, exemplary components of a voice assistant device show the voice interface with microphone input, large language model, speaker output, screen output, other user input devices, user data storage, and other data storage, consistent with the disclosed embodiments. More specifically, the voice assistant device includes a voice interface (201). The voice interface (201) is configured to receive spoken inputs from the user through a microphone (202) or other voice input devices. The voice interface (201) is further configured to perform advanced speech recognition to accurately transcribe the intended meaning of inputs into text, including prosody analysis to detect emotional cues. The voice interface (201) is able to disambiguate between two intended meanings of an input, process complex or multi-part questions or inputs with multiple intents, and understand context-dependent queries based on conversation history. The voice interface (201) is further configured to transform the spoken input into a form that a large language model (203) can process, such as a text input.

The voice interface (201) is also configured to receive other inputs that are not spoken through other user input devices (207). The other user input devices (207) include input devices configured to receive active user inputs, such as a keyboard configured to receive typed messages or a camera configured to detect gestures, as well as input devices configured to receive passive user inputs, such as a camera configured to detect facial expressions. The voice interface (201) includes computer vision models to recognize and interpret gestures and facial expressions. The voice interface (201) is optionally configured to correct and clarify input mistakes such as typos, keywords, incomplete inputs, and other input mistakes. The voice interface (201) analyzes the other inputs received from the other user input devices (207) and transforms the other inputs into a form that the large language model (203) can process, such as a text input. For example, the voice assistant translates abbreviations or numbers into a form that the large language model can process more easily or more accurately.

The voice interface (201) is further optionally configured to send the original or transformed spoken or other inputs to the large language model (203). The voice interface (201) combines a plurality of inputs from a plurality of input devices to create one input to send to the large language model (203). The large language model (203) is configured to receive the input from the voice interface, generate a responsive output, and send the responsive output to the voice interface (201).

The large language model (203) is optionally a custom large language model. The large language model (203) is configured to recognize diverse phrasings and terminologies that may express the same intent. The large language model (203) optionally uses natural language processing techniques to understand and generate humanlike language patterns. The large language model (203) contextually understands user queries, recognizes colloquialisms, idioms, and regional expressions, and interprets and/or responds to complex, multi-part user inputs. The large language model (203) adapts to evolving user language and new expressions over time. The large language model (203) optionally uses humor and casual language when appropriate.

The large language model (203) or the voice interface (201) optionally introduce controlled imperfections into the outputs to create a more humanlike output. The controlled imperfections include, for example, occasional hesitations, self-corrections, admitting uncertainty or a lack of knowledge, subtle variations in response time to mimic human thought, and other controlled imperfections. The voice interface (201) optionally performs text-to-speech synthesis involving emotion modulation on the responsive output generated by the large language model (203) to generate outputs that are humanlike.

The voice interface (201) and the large language model (203) is optionally configured to incorporate consistent personality traits and a backstory into the voice assistant. This includes, for example, maintaining a consistent tone across different conversations and using style transfer techniques to adapt outputs to align with the voice assistant\'s personality traits and backstory.

The voice interface (201) is optionally configured to output the responsive output to the user through a speaker (204) as an audio output, to a screen (205) as text or graphical output, or through any other output method or medium. The voice interface (201) is further optionally configured to send an output to more than one output medium at once or to output a single output across multiple output devices. The voice interface optionally determines which output method or methods to use based on the conversational context. Some of the input and output components and methods perform dual functions, such as a screen providing a user interface that functions as an input method for the user that also functions as an output method for text, images, and other user interface elements.

The voice interface (201) optionally includes conversation steering rules or techniques that reject or modify inputs or outputs in order to keep the user or the voice assistant from deviating from certain topics or from discussing certain topics. The voice interface (201) optionally includes a turn-taking mechanism to mimic natural dialogue, where the voice interface will attempt to respond only when the user has finished providing input. The voice interface (201) optionally incorporates appropriate pauses and filler words into the output to simulate human speech patterns.

The voice interface (201) optionally determines to selectively send or not send certain inputs to the large language model (203) based on whether the user would expect to receive a response from the voice assistant. For example, if the user nods in response to a question from the voice assistant, the voice assistant may need the large language model to generate the next conversation output. Similarly, if the user rolls their eyes while speaking, the large language model may need that information to generate an appropriate output to respond to the spoken input, but the large language model may not need to generate a separate response to the eye roll.

The voice assistant optionally includes user data (206) such as previous conversation records, recorded emotional and context data, and other forms of user data. The user data (206) is stored locally or on a cloud server. The user data (206) if optionally stored locally even if the voice assistant operates on a cloud server. The voice interface (201) optionally stores user data relating to inputs that the voice interface (201) receives, including inputs that are sent to the large language model (203) and inputs that are not sent to the large language model (203). The voice assistant is optionally configured to save a conversation state as user data (206) and resume the conversation at a later time. The user data (206) is optionally anonymized and encrypted when possible to provide ethical and privacy considerations to the user. The voice assistant is optionally configured to not collect or store data without receiving the user's consent, consistent with data privacy regulations and ethical guidelines.

The voice assistant is optionally configured to use the user data (206) for a variety of purposes. The user data includes personal information such as user demographics and preferences to allow the voice assistant to adjust the language and tone of outputs to account for cultural nuances and sensitivities. The user data optionally includes contextual memory where the previous parts of the conversation and prior conversations are recorded and can be utilized by the voice assistant to create responsive outputs. The voice assistant is optionally configured to interpret ambiguous voice inputs based on the contextual memory or historical inputs or emotional states. For example, if a user in a previous conversation had clarified that an ambiguous input was their pronunciation of a particular word, the voice assistant is configured to recognize that word in future conversations without needing clarification from the user. Similarly, if the user has reacted positively or negatively to outputs with certain attributes, the voice assistant may attempt to generate more or less outputs with those attributes. The dynamic nature of a conversation may require the voice assistant to compare the circumstance that the user data (206) was generated and the present circumstance to determine if the voice assistant should adjust its operations. By dynamically updating and relying on the user data (206) to adjust the operation of the voice assistant, the voice assistant may be able to more accurately interpret and respond to user inputs, creating an improved user experience.

The voice assistant optionally includes other data (208). The other data (208) includes, for example, data received from external sources such as search engines and may include data generated and saved by the voice assistant that is not user data. The other data (208) is optionally updated frequently to allow the voice assistant to generate relevant and accurate outputs and responses. The other data includes aggregated, anonymized, or benchmark data from other voice assistants or external sources, subject to applicable data-governance and privacy policies.

The voice assistant optionally perform functions in addition to generating responses and having conversations with the user. For example, the voice assistant functions as a security or authentication system by using voice analysis to match an input with previous voice inputs to confirm the identity of a user. Inputs may be matched based on user data such as emotional markers. The voice assistant further performs other optional functions, such as controlling connected devices or providing other helpful features and functions to the user. For example, the voice assistant helps the user maintain a personal journal by prompting the user for inputs such as specific thoughts and then record those thoughts into a journal. The voice assistant may provide additional benefits beyond recording the thoughts such as analysis of the user's thoughts. The voice assistant automatically categorizes and analyzes, for example, the user's inputs to provide insights or identify trends.

Referring now to FIG. 2B, generally, an exemplary operation of the voice assistant shows a feedback loop cycle of receiving user input, generating a responsive output, transmitting the output, determining whether the output caused a positive experience, and adjusting future outputs and internal operations, consistent with the disclosed embodiments. More specifically, the voice assistant implements an adaptive feedback loop for continuous improvement. At step (211), the voice assistant receives a user input and begins a conversation. At step (212), the voice assistant generates a responsive output to the user input. At step (213), the voice assistant transmits the output to the user through the appropriate output device or medium. At step (214), the voice assistant determines, based on additional user input and other data, whether the output caused a positive experience for the user. At step (215), the voice assistant adjusts future outputs and internal operations to be more likely to cause positive experiences for the user.

If the voice assistant determines at step (214) that a particular output did not cause a positive experience for the user, the voice assistant produces outputs in the future that are dissimilar to the particular output. If at step (214) the voice assistant determines that the particular output caused a positive experience, the voice assistant produces outputs in the future that are similar to the particular output. The voice assistant optionally includes adaptive or machine learning algorithms to allow the voice assistant to learn from the conversations with the user, refine or improve responses, adapt to user preferences and communication style, and continuously improve the voice assistant.

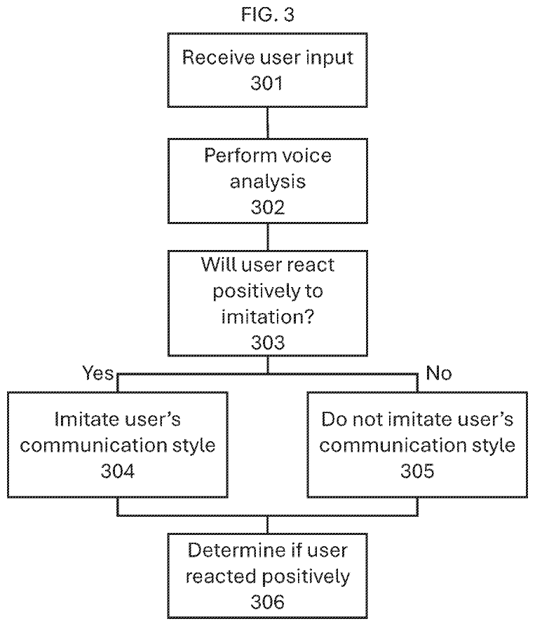

Referring now to FIG. 3, generally, an exemplary operation of the voice assistant is directed to adaptive communication style adjustment, showing voice analysis, determination of whether imitating the user's communication style will produce positive results, style adjustment or non-adjustment, and evaluation of user response, consistent with the disclosed embodiments. More specifically, the voice assistant implements adaptive communication style adjustment. At step (301), the voice assistant receives user input. At step (302), the voice assistant performs voice analysis on the user input. The voice analysis includes detecting the user's emotional state, recording the user's communication style including their personality, tone, speaking rate, expressiveness, and language patterns.

At step (303), the voice assistant determines, based on the voice analysis, recorded user data, and other information, whether imitating the user's communication style will cause the voice assistant\'s outputs to be received positively by the user, for example by making the outputs seem more personalized and empathetic. If the user reacts positively to a voice assistant that has a similar communication style as their own, the voice assistant at step (304) adjusts its outputs by imitating the user's communication style. If the user does not react positively, the voice assistant at step (305) adjusts its outputs by not imitating the user's communication style.

Step (305) includes changing the voice assistant's communication style to be different than the user's communication style, preferably to be more personalized and empathetic. Alternatively, step (305) includes not changing the voice assistant\'s communication style. The voice assistant, then, at step (306) evaluates whether the user has reacted positively to the adjusted output. For example, a user whose inputs are generally excited may react positively to an excited voice assistant. Alternatively, a user whose inputs are generally angry may have a negative or undesirable interaction with a voice assistant that imitates the angry communication style of the user. However, the same angry user may have a positive and enjoyable interaction with a voice assistant that presents a calmer communication style.

The operation described with respect to FIG. 3 occurs over a period of time and is applied to future conversations with the same user. The voice assistant determines that a user responds positively to responses that imitate the user's communication style and then imitates the user's communication style in future conversations with the same user. The voice assistant adjusts its outputs incrementally over time, increasing the imitation or other adjustments in consecutive conversations and reevaluating whether further adjustments will create a positive reaction each time.

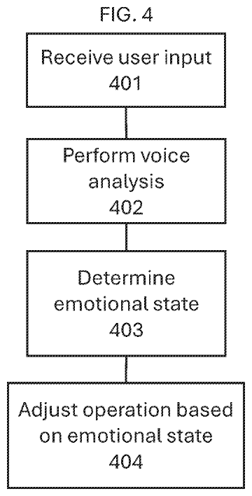

Referring now to FIG. 4, generally, an exemplary operation of the voice assistant is directed to an emotional state-based response adjustment showing voice analysis, emotional state determination, and operational adjustment including task prioritization, workflow modification, response modification, and user interface adjustment, consistent with the disclosed embodiments. More specifically, the voice assistant implements emotional state detection and response adjustment. The voice assistant receives user input at step (401) and performs voice analysis at step (402). At step (403), the voice assistant determines, based on the voice analysis, recorded user data, and other information, the emotional state of the user.

Based on the emotional state of the user, the voice assistant at step (404) adjusts its operation in one or more of the following ways. The voice assistant prioritizes tasks, adjusts its workflow, and modifies its responses based on the detected emotional state of the user to meet the user's emotional needs or improve the user experience. If the voice assistant at step (403) determines that the user's emotional state is a state of distress, the voice assistant connects the user to support resources or human intervention. The voice assistant optionally provides the support directly to maintain the conversation and user interaction, and not require the user to end the discussion to receive needed support.

The voice assistant is able to adjust its user interface based on the user's emotional state. A user with a certain emotional state may react positively to a user interface that is a certain color, that contains more or less complexity, or that involves more or less motion, among many other possible adjustments.

The voice assistant performs emotional state detection through prosody analysis of the user's spoken input. Representative prosody features extracted from the user's speech include pitch mean and variance, speaking rate (tempo), pause frequency and duration, energy contour (loudness), and spectral tilt (voice quality characteristics). These features are mapped to a representative set of emotional-state labels including neutral, frustrated, anxious, enthusiastic, and confused. The mapping is optionally performed using a trained neural network classifier that learns associations between prosody features and emotional states, or alternatively using a rule-based lookup approach with predetermined thresholds for each feature. For example, elevated speaking rate and energy may indicate enthusiasm, while reduced energy and longer pauses may indicate frustration or confusion. The emotional state determination provides the voice assistant with critical context for tailoring response content, communication style, and interaction approach to match the user's emotional needs.

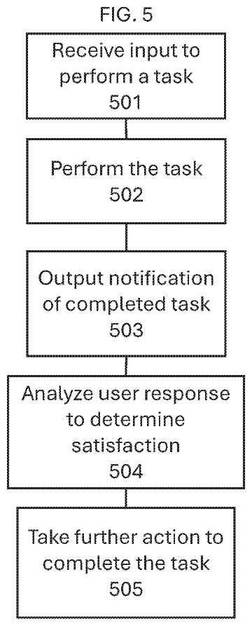

Referring now to FIG. 5, generally, an exemplary operation of the voice assistant is directed to task execution with satisfaction monitoring, showing task request receipt, task performance, completion notification, satisfaction analysis, and corrective action, consistent with the disclosed embodiments. More specifically, the voice assistant implements task execution with satisfaction monitoring. At step (501), the voice assistant receives an input from the user requesting the voice assistant to perform a task. At step (502), the voice assistant performs the requested task. At step (503), the voice assistant outputs to the user a notification that the task has been completed. The notification is optionally a spoken output generated by the large language model, a visual notification on a screen, or any other suitable notification method.

At step (504), the voice assistant analyzes the user's response to determine if the task has been completed to the user's satisfaction. The voice assistant analyzes the user's emotional state, any user inputs that are received in response to the notification at step (503), and any other information the voice assistant has access to at step (504). If the voice assistant determines that the task has not been completed to the user's satisfaction, or if the user's response is negative for other reasons, the voice assistant at step (505) takes further action to complete the task or to improve the user's reaction to the previously performed actions.

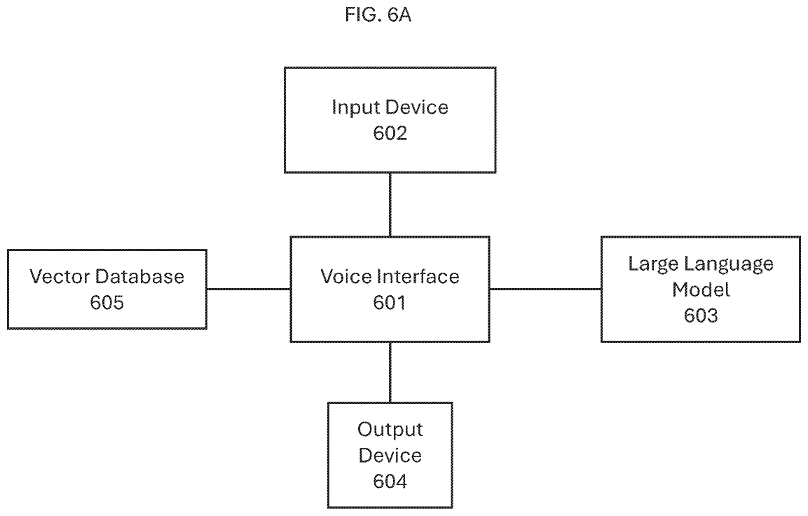

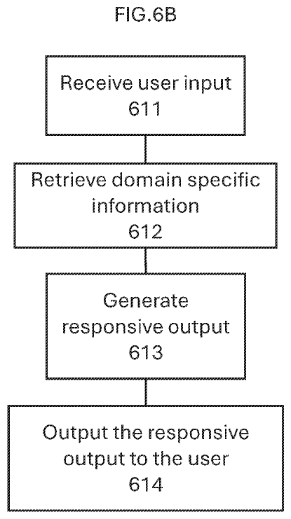

Referring now to FIG. 6A, generally, exemplary components of a voice assistant device, which performs retrieval augmented generation, include a voice interface, input device, vector database containing domain-specific data, large language model, and output device, consistent with the disclosed embodiments. More specifically, the voice assistant is configured to perform retrieval augmented generation. The voice assistant includes a voice interface (601) that receives user inputs from an input device (602). The voice assistant includes a vector database (605) containing data that is domain-specific.

The vector database (605) is optionally a database of health-related data created by training the vector database (605) on health-related information and documents. Alternatively, the vector database is a database of other domain-specific data such as legal data, business data, market data, or any other domain-specific data. The voice interface (601) retrieves from the vector database (605) domain-specific information that is relevant to the user input received from the input device (602). The voice interface (601) sends the user input and the retrieved domain-specific information to the large language model (603) in a form the large language model (603) can process, such as a text prompt. The large language model (603) generates a responsive output based on the input and the domain-specific information and sends the responsive output to the voice interface (601). The voice interface (601) outputs the responsive output to the user using an output device (604).

The voice assistant assembles a multi-layer prompt architecture including a user query layer that contains the current user input and conversation history, a retrieved knowledge layer that includes the relevant information retrieved from a domain-specific database, an emotional context layer that contains emotional information determined by analyzing the user's inputs, a system instruction layer that contains behavioral guidelines for the voice assistant\'s response generation including predefined assistant guidelines and safety constraints, and a personalization layer that includes user-specific information and preferences.

According to one exemplary embodiment, the term “not acceptable” when applied to a generated response refers to a response that either matches a stored rejection rule in the system configuration or triggers a confidence score below a predetermined threshold (for example, below 0.70 on a normalized confidence scale). According to another exemplary embodiment, the term “topical boundaries” refers to a predefined set of permitted subject-matter categories stored in a configuration database, against which user inputs and system outputs are compared. According to another exemplary embodiment, the term “controlled imperfections” refers to predetermined variations in response phrasing, hesitation timing, self-correction patterns, and response latency selected from a library of alternatives designed to create more natural conversational interactions. According to another exemplary embodiment, the term “positive user experiences” is determined through user satisfaction signals detected either explicitly (e.g., user affirmation or ratings) or implicitly (e.g., continued conversation engagement, task completion, or absence of negative feedback). According to another exemplary embodiment, the term “humanlike,” as applied to voice output, refers to incorporating into the response natural speech variation, emotion-modulated prosody (pitch, tempo, energy variations), and conversational turn-taking patterns that mimic human dialogue rather than robotic or monotonic speech.

The voice assistant further optionally include features that make the user experience more similar to a human conversation. The voice assistant optionally adjusts its speech patterns including its speed, volume, tone, and other aspects based on the emotional context of the user input. The voice assistant optionally maintains continuity between multiple user inputs and voice assistant outputs in a sequence. The voice assistant optionally produces proactive outputs by anticipating the needs of the user and providing outputs to meet those needs, such as by providing relevant information or support. The voice assistant further optionally analyzes the user inputs to determine when to speak to ensure smooth conversation flow.

Referring now to FIG. 6B, generally, an exemplary operation of the voice assistant is directed to performing retrieval augmented generation, showing user input receipt, domain-specific information retrieval, response generation using the input and retrieved information, and output to user, consistent with the disclosed embodiments. More specifically, at step (611) the voice assistant receives a user input. At step (612), the voice assistant retrieves domain-specific information that is relevant to the user input. At step (613), the voice assistant generates a responsive output based on the user input and the retrieved domain-specific information. Step (613) is performed by providing the domain-specific information to a large language model. At step (614), the voice assistant outputs the generated responsive output to the user.

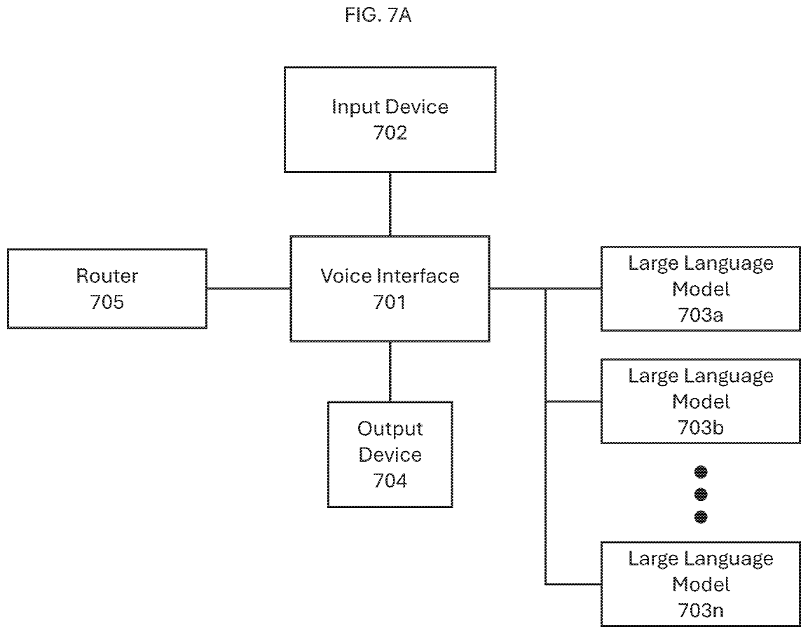

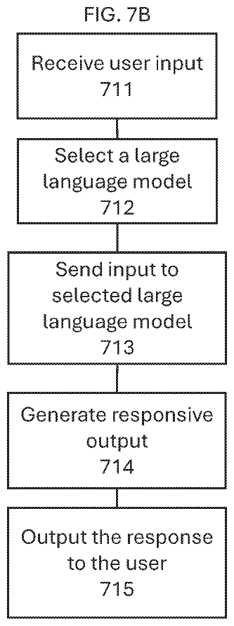

Referring now to FIG. 7A, generally, exemplary components of a voice assistant device that shows a voice interface includes an input device, a router, a plurality of large language models, and an output device, consistent with the disclosed embodiments. More specifically, the voice assistant includes a voice interface (701) that receives user inputs from an input device (702). The voice assistant is configured to communicate with a plurality of large language models (703a), (703b), and any number n of additional large language models (703n). The voice assistant includes a router (705) that is configured to select a large language model from the various large language models (703a) through (703n). The voice interface sends the user input to the large language model that the router selected in a form the large language model can process, such as a text prompt. The selected large language model generates a responsive output based on the input and sends the responsive output to the voice interface (701). The voice interface (701) outputs the responsive output to the user using an output device (704).

The router (705) selects a large language model from the plurality of large language models (703a) through (703n) in a number of different ways. The router (705) optionally selects the large language model based on a predetermined priority list, based on a user's selection of a preferred large language model, and/or based on user data or other data that demonstrates increased user satisfaction with a particular large language model. The router (705) optionally tracks metrics of the large language models such as their performance, latency, and cost, and use those tracked metrics to select the best large language model at the time the user initiates a conversation with the voice assistant. The router (705) further, optionally, selects the large language model based on the initial prompt given by a user in a conversation.

The router (705) optionally includes a fallback mechanism whereby a first large language model is selected based on a first condition, and a second large language model may be used if a second condition is fulfilled. The router switches the selected large language model from a first large language model to a second large language model if the selected large language model stops working, is not providing outputs that receive the desired response from the user, and/or is failing to meet the goals of the voice assistant in other ways. Alternatively, the router (705) switches to the second large language model if the user instructs the voice assistant to switch to a new large language model, if the user asks the voice assistant to respond again but differently, and/or if a different large language model could provide a better output to a new input prompt that the user provides. As part of the function of the fallback mechanism, the router (705) or the voice interface (701) analyze outputs provided by the selected large language model before the outputs are sent by the voice interface (701) to the output device (704). Outputs that are determined to be an error, or outside the voice assistant guidelines, or are otherwise not acceptable are prevented from being sent to the user. The router (705) then selects a second large language model and the voice interface (701) then receives a second output message from the second large language model and analyze the second output message. The voice assistant repeats this process until a suitable output message has been generated.

In one representative implementation, the router (705) scores each available large language model on weighted factors of latency (priority weight 0.3), cost (priority weight 0.2), and prior user-satisfaction metrics (priority weight 0.5), ranks the models by composite score, and selects the highest-ranked model that is currently available and responsive. The fallback trigger is executed when the response screening step (as described in [0040a]) determines either that: (a) the response matches a stored rejection rule in the configuration database, or (b) the confidence score calculated from the response quality assessment falls below the predetermined threshold (for example, 0.70 on a normalized 0-1 scale). Upon fallback trigger, the system routes the user input to the next-highest-ranked available model and repeats the generation and screening process until an acceptable response is generated or all models have been attempted.

The voice interface (701) optionally includes an abstraction layer that allows the voice interface to provide appropriate inputs to each of the plurality of large language models (703a) through (703n). Different large language models have different input requirements or API formats and have other differences that limit the ability to use one input or one form of input in all large language models. The abstraction layer transforms the input received from the input device (702) into a form that the currently selected large language model can process correctly. The abstraction layer also transforms outputs from the selected large language model to make them compatible and consistent with previous outputs in the same conversation or in previous conversations with the same user. The voice assistant provides different initial prompts to different large language models based on preprogrammed or learned correlation between certain initial prompts and outputs that can be used by the voice assistant.

The plurality of large language models (703a) through (703n) is optionally a predetermined set of large language models. The voice assistant is configured to allow the user to select desired large language models from a predetermined list of large language models. The voice assistant is configured to allow the user to add any large language model to the plurality of large language models, including custom or commercial large language models. The voice assistant optionally allows a user to log in with a user account for a commercial large language model and then use the user account if the router selects that large language model, allowing the user to access improved features that are available to that user account.

Referring now to FIG. 7B, generally, an exemplary operation of the voice assistant, which is configured to select a large language model from a plurality of large language models, includes user input receipt, model selection, input transformation, response generation, and output to user, consistent with the disclosed embodiments. More specifically, at step (711) the voice assistant receives a user input. At step (712), the voice assistant selects a large language model from a plurality of connected large language models. The router selects at any time a second large language model that is different from the selected large language model. At step (713), the voice assistant sends the input to the selected large language model in a form the large language model can process. At step (714), the large language model generates a responsive output. At step (715), the voice assistant outputs the generated responsive output to the user.

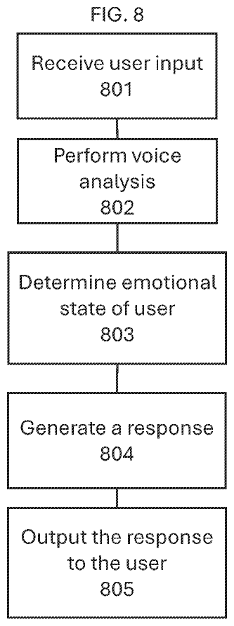

Referring now to FIG. 8, generally, an exemplary operation of the voice assistant shows a method that includes receiving user input, performing voice analysis, determining emotional state, generating a response using a large language model, and outputting the response, consistent with the disclosed embodiments. More specifically, at step (801) the voice assistant receives a user input on an input device. At step (802), the voice assistant performs voice analysis on the user's input. At step (803), the voice assistant determines, based on the voice analysis, an emotional state of the user. At step (804), the voice assistant generates, using a large language model, a response to the user input. At step (805), the voice assistant outputs, to the user, the response, using an output device.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A computer-implemented method for operating a voice assistant, comprising:
receiving a spoken input from a user through a microphone or voice-enabled input device;
performing voice analysis on user input, the voice analysis including prosody analysis to detect emotional cues in the user's speech, wherein the prosody analysis extracts from the speech pitch, tempo, energy, and spectral-tilt features;
determining, based on the voice analysis, an emotional state of the user by mapping the extracted prosody-derived features to an emotional-state label from a predefined emotional-state set;
selecting, using a router, a large language model from a plurality of large language models based on weighted scoring of latency, cost, and prior user-satisfaction metrics;
assembling a multi-layer prompt for the selected large language model, the prompt incorporating a user query layer containing the current user input and conversation history, a retrieved knowledge layer containing domain-specific information, an emotional context layer containing the determined emotional-state label, a system instruction layer containing predefined assistant guidelines, and a personalization layer containing user-specific preferences;
generating, using the selected large language model, a response to the user input based on the assembled prompt;
screening the generated response by comparing it against stored rejection rules in a configuration database and determining a confidence score, and replacing the response or selecting a fallback large language model from the plurality of large language models when the confidence score is below a predetermined threshold or when the response matches a stored rejection rule; and
outputting, to the user, the response, using an output device, wherein the output incorporates modulation of text-to-speech parameters based on the determined emotional state.

2. The method of claim 1, further comprising:
selecting the selected large language model based on at least one of a predetermined priority list, a user selection, user satisfaction data, tracked performance metrics including latency and cost, or the content of the user input;
transforming the user input to a form that the selected large language model can process using an abstraction layer; and
generating, using the selected large language model, the response to the user input.

3. The method of claim 2, further comprising:
retrieving, from a vector database containing domain-specific information, domain-specific information relevant to the user input; and
providing the domain-specific information to the selected large language model;
wherein the selected large language model generates the response based on the user input and the provided domain-specific information, and wherein the vector database contains domain-specific data relevant to the user input.

4. The method of claim 2, further comprising:
analyzing outputs provided by the selected large language model before the outputs are sent to the output device by comparing the outputs against stored rejection rules and determining a confidence score;
determining that the outputs are unacceptable when the confidence score is below a predetermined threshold or when the outputs match a stored rejection rule;
selecting another large language model from the plurality of large language models; and generating another response using the another large language model.

5. The method of claim 2, wherein the abstraction layer transforms the response to a form that is consistent with previous responses in the same conversation or in previous conversations with the same user, and wherein the voice assistant provides different initial prompts to different large language models based on preprogrammed or learned correlations between initial prompts and output quality.

6. The method of claim 1, further comprising:
performing voice analysis to detect a user communication style including at least one of tone, speaking rate, expressiveness, or language patterns;
determining whether adjusting the communication style will cause increased satisfaction based on detected user affirmation, user ratings, continued conversation engagement, task completion, or absence of negative feedback; and
adjusting the voice assistant's outputs by imitating or not imitating the user communication style based on the determination, wherein the adjusting is performed incrementally over a period of time across multiple conversations with the same user based on detected user satisfaction signals and predefined adjustment rules.

7. The method of claim 1, further comprising:
introducing controlled imperfections into the response, the controlled imperfections comprising at least one of occasional hesitations, self-corrections, admitting uncertainty, or subtle variations in response time; and
performing text-to-speech synthesis involving emotion modulation on the response to modulate speech speed, volume, tone, and other aspects of speech output based on the determined emotional state.

8. The method of claim 1, further comprising:
applying conversation steering rules that reject or modify inputs or outputs to maintain topical boundaries; and
applying a turn-taking mechanism that responds only when the user has finished providing input.

9. The method of claim 1, further comprising assembling a prompt for the large language model incorporating a plurality of context layers that includes a user query layer containing the current user input and conversation history, a retrieved knowledge layer containing domain-specific information retrieved from a database, an emotional context layer containing emotional information determined from voice analysis including prosody-derived emotional-state labels, a system instruction layer containing predefined assistant guidelines and behavioral constraints for response generation, and a personalization layer containing user-specific information and preferences.

10. The method of claim 1, further comprising:
receiving a task request from the user; performing the requested task;
outputting a notification of task completion;
determining user satisfaction based on detected user affirmation, user ratings, continued conversation engagement, task completion, or absence of negative feedback; and
taking corrective action when user satisfaction feedback is negative.

11. The method of claim 1, further comprising:
receiving inputs from a plurality of input devices including a microphone, a keyboard, and other input devices;
combining voice and text inputs into a single representation for the large language model; and
selectively sending or not sending certain inputs to the large language model based on whether the user would expect to receive a response from the voice assistant.

12. The method of claim 1, further comprising:
receiving user satisfaction signals through user responses and interactions;
determining whether outputs caused positive user experiences based on detected user affirmation, user ratings, continued conversation engagement, task completion, or absence of negative feedback; and
adjusting future outputs based on predefined adjustment rules and stored conversation history.

13. The method of claim 1, further comprising:
assembling the multi-layer prompt to incorporate an emotional-context layer containing the determined emotional-state label and the determined emotional-state label information, wherein the emotional-context layer enables the selected large language model to generate contextually-aware and emotionally-responsive outputs;
iteratively applying the fallback mechanism by selecting the next-highest-ranked large language model from the plurality when the response screening determines the response is not acceptable; and
repeating the response generation and screening steps using the fallback model until an acceptable response is generated or until all available large language models in the plurality have been attempted.

14. A non-transitory computer-readable medium storing a set of instructions, the set of instructions comprising one or more instructions that, when executed by one or more processors of a device, cause the device to:
receive a spoken input from a user through a microphone or voice-enabled input device;
perform voice analysis on user input, the voice analysis including prosody analysis to detect emotional cues in user speech, wherein the prosody analysis extracts from the speech pitch, tempo, energy, and spectral-tilt features;
determine, based on the voice analysis, an emotional state of the user by mapping the extracted prosody-derived features to an emotional-state label from a predefined emotional-state set; select, using a router, a large language model from a plurality of large language models based on weighted scoring of latency, cost, and prior user-satisfaction metrics;
assemble a multi-layer prompt for the selected large language model, the prompt incorporating a user query layer containing current user input and conversation history, a retrieved knowledge layer containing domain-specific information, an emotional context layer containing the determined emotional-state label, a system instruction layer containing predefined assistant guidelines, and a personalization layer containing user-specific preferences;
generate, using the selected large language model, a response to the user input based on the assembled prompt;
screen the generated response by comparing it against stored rejection rules in a configuration database and determining a confidence score, and replacing the response or selecting a fallback large language model from the plurality when the confidence score is below a predetermined threshold or when the response matches a stored rejection rule; and
output, to the user, the response, using an output device, wherein the output incorporates modulation of text-to-speech parameters based on the determined emotional state.

15. The non-transitory computer-readable medium of claim 14, further comprising instructions to:
select, using a router, a large language model from a plurality of large language models based on at least one of a predetermined priority list, user satisfaction data, tracked performance metrics including latency and cost, or the content of the user input;
transform the user input to a form that the selected large language model can process using an abstraction layer; and
generate, using the selected large language model, the response to the user input.

16. The non-transitory computer-readable medium of claim 15, further comprising instructions to:
retrieve, from a vector database containing domain-specific information, domain-specific information relevant to the user input;
provide the domain-specific information to the selected large language model; and
analyze outputs provided by the selected large language model before sending the outputs to the output device by comparing against stored rejection rules and determining a confidence score, and switch to another large language model when the confidence score is below a predetermined threshold or when the outputs match a stored rejection rule.

17. The non-transitory computer-readable medium of claim 14, further comprising instructions to assemble a prompt incorporating a plurality of context layers that includes a user query layer containing the current input and conversation history, a retrieved knowledge layer containing domain-specific information, an emotional context layer containing prosody-derived emotional information, a system instruction layer containing predefined behavioral guidelines, and a personalization layer containing user-specific information.

18. The non-transitory computer-readable medium of claim 14, further comprising instructions to:
detect a user communication style including tone, speaking rate, expressiveness, and language patterns;
incrementally adjust the voice assistant's communication style across multiple conversations based on detected user affirmation, user ratings, continued conversation engagement, task completion, or absence of negative feedback, and predefined adjustment rules; and
introduce controlled imperfections into responses including occasional hesitations, self-corrections, and variations in response time.

19. A voice assistant system comprising:
a voice interface configured to receive spoken inputs from a user through a microphone and text inputs from other user input devices;
a voice analysis module within the voice interface configured to perform prosody analysis to extract pitch, tempo, energy, and spectral-tilt features, and to determine an emotional state of the user by mapping the extracted prosody-derived features to emotional-state labels from a predefined emotional-state set;
a plurality of large language models configured to receive inputs and generate responsive outputs;
a router configured to select one large language model from the plurality of large language models based on weighted scoring of latency, cost, and prior user-satisfaction metrics;
an abstraction layer configured to transform user inputs to a form processable by the selected large language model and to transform outputs for consistency across different models and conversations;
a response screening module configured to compare generated responses against stored rejection rules in a configuration database and determine a confidence score;
a fallback mechanism configured to switch to a next-highest-ranked large language model from the plurality when the generated response matches a stored rejection rule or when the confidence score is below a predetermined threshold;
a vector database containing domain-specific information, wherein the voice interface is configured to retrieve domain-specific information relevant to user inputs and provide the retrieved information to the selected large language model;
a prompt assembly module configured to assemble multi-layer prompts incorporating a user query layer, a retrieved knowledge layer, an emotional context layer containing the determined emotional-state label, a system instruction layer, and a personalization layer; and
an output system configured to output responsive outputs through at least one of a speaker or screen, wherein the responsive outputs incorporate emotion-modulated text-to-speech parameters based on the determined emotional state.

20. The system of claim 19, further comprising:
a prompt assembly module configured to assemble prompts incorporating a plurality of context layers that includes a user query layer containing a current user input and conversation history, a retrieved knowledge layer containing domain-specific information, an emotional context layer containing prosody-derived emotional information, a system instruction layer containing predefined behavioral guidelines and safety constraints, and a personalization layer containing user-specific information; and
an adaptive communication style module configured to detect a user communication style including tone, speaking rate, expressiveness, and language patterns, and incrementally adjust the voice assistant's communication style across multiple conversations based on detected user satisfaction signals and predefined adjustment rules.
